(19) United States
(12) Patent Application Publication
(10) Pub. No.: US 2012/0104742 A1
(43) Pub. Date: May 3, 2012

(54) GAME TICKET

(76) Inventors: Lyle Scrymgeour, Oakbank (CA); Michael John Brickwood, Winnipeg (CA); Sina Aiello, Winnipeg (CA); Todd Lyall, Winnipeg (CA); Norm Hagman, Winnipeg (CA); Shelly Carlson, Barrhead (CA); Dion Grotkowski, Brighton, MI (US); Michael Michaud, Barrhead (CA)

(21) Appl. No.: 13/105,995

(22) Filed: May 12, 2011

Related U.S. Application Data
(60) Provisional application No. 61/346,511, filed on May 20, 2010.

(51) Int. Cl. B42D 15/00

(52) U.S. Cl. 283/85; 283/100

(57) ABSTRACT

A lottery ticket is formed by a substrate sheet material on which is printed game and other indicia with some or all of the game indicia being covered by a scratch-off material removable by the player. A ticket viewing device in the form of a flat panel defining glasses may be contained in a pocket formed on one side of the sheet or they can be supplied separate from the ticket. The glasses are used by the player for viewing the ticket with at least some of the indicia being printed in a manner which cooperates with the ticket viewing device so that the indicia are visible to the player in a three dimensional format. The pocket can be formed an attached layer of a different material for example of transparent plastic or the pocket can be formed by folding one edge of the substrate.

This application claims the benefit under 35 USC 119 of Provisional Application 61/346,511 filed May 20th 2010.

This invention relates to game or lottery ticket.

### BACKGROUND OF THE INVENTION

Lottery tickets are well known and widely sold and typically comprised of a sheet material of paper or card stock on which is printed lottery information and various indicia for the playing of one or more games. Many such games are instant win type games where the player can play the game or games by carrying out various functions, for example, opening pull tabs on a break-open ticket.

In U.S. Pat. No. 7,070,054 of the present applicant issued Jul. 4, 2006 is disclosed packaging material is provided in a continuous roll for forming into a channel shaped receptacle for receiving and supporting a structure such as a food product to be packaged by an over-wrap material. The packaging material is formed from two substrate sheets connected together along side edges to form a coextensive laminate defining a center portion and two side strip portions where the center portion has a width arranged to form the bottom wall and the two side strip portions each have a width arranged to form a respective one of the upstanding side walls. The center portions can be separated and exposed by tearing away the side and end portions and the inside surface of the center portions carries printed indicia providing a remanent value therefor, such as a scratch-off type lottery game or a collectible card.

Break-open tickets are typically constructed by printing a sheet containing multiple combinations of lottery indicia thereon. This sheet is then cut into sections. The opposite side of this sheet includes prize categories, serial number etc. A second sheet which contains removable tabs or break-open windows is then mounted onto the card stock such that the break-open windows overlap the lottery indicia. However, break-opens prepared in this manner have the disadvantages that they are cumbersome to prepare, have a limited set of winning symbols and require manually checking at the time of redemption.

U.S. Pat. No. 4,174,857 (Kota) and U.S. Pat. No. 5,253,899 (Greenwood) each disclose a combined ticket construction in which a second layer is applied or folded over the basic ticket to improve security. U.S. Pat. No. 5,562,284 discloses a break-open ticket with a second level of break-open. U.S. Pat. No. 5,217,258 (Sanderson) discloses a two sided break-open ticket where the windows are arranged back to back opening onto a single center sheet carrying the game data.

As shown in U.S. Pat. No. 6,494,975 issued Dec. 17, 2002 of the present applicants there is provided a pouched lottery ticket which is supplied in a fan folded continuous strip arrangement for separating each ticket from the next at a dispensing station.

In U.S. Pat. No. 6,234,477 of the present applicants issued May 22, 2001 is disclosed a construction of lottery ticket which utilizes variable image printing techniques in combination with lamination of two substrate sheets together to form what is initially a common pouch construction with the game indicia on the inside surface where the sheets can be separated, each from the other, to form in effect two separate tickets.

The above patents and products available on the marketplace generally provide simply a lottery or game ticket printed on a suitable single substrate sheet or on laminated sheets where the tickets are intended to be used individually simply for playing of a game and are then discarded.

Many such tickets are used directly in a lottery situation so that the tickets have no other relevance other than the playing of the lottery or game by which the player may win monetary or other prizes as part of the lottery or gaming situation.

One important issue with lottery and similar game tickets is that of providing sufficient appeal to the public to ensure a sale of the ticket bearing in mind that such sales are commonly an impulse purchase based on ticket appearance.

### SUMMARY OF THE INVENTION

It is one object of the invention to provide an improved game or lottery ticket.

According to one aspect of the invention there is provided a game ticket assembly for playing by a player comprising:

a ticket comprising:

a substrate sheet material;

indicia printed on the substrate sheet material including:

promotional graphics printed on the substrate sheet material;

game information printed on the substrate sheet material;

and game indicia printed on the substrate sheet material;

some or all of the game indicia being covered by a material removable by the player;

and a ticket viewing device usable by the player for viewing the ticket;

at least some of the indicia being printed in a manner which cooperates with the ticket viewing device so that the indicia are visible to the player in a three dimensional format in which some parts of the indicia are apparently transported out of a two dimensional plane of the substrate sheet material.

Preferably the ticket viewing device, typically in the form of viewing glasses, is associated with the ticket so that each of a series of tickets has a respective ticket viewing device associated therewith. However the glasses may be supplied as a separate item which the player keeps and uses repeatedly with different tickets.

Thus preferably the ticket viewing device is attached to the ticket for transportation therewith, but it can be supplied as a separate item.

Preferably the ticket viewing device comprises glasses including two lenses for the eyes of the player. Thus the system for forming the 3D image can be of the type shown in U.S. Pat. Nos. 4,717,239; 4,597,634 and 5,000,364 of Georgia Tech, the disclosures of which is incorporated herein by reference. These show a system known as ChromaDepth 3D (trade mark) which is based on the prismatic effect in which different colors appear to be positioned at varying levels thus adding the 3rd dimension to 2D printed or computer images. However the conventional red/blue type of images which are more familiar can be used. While these systems use glasses with two lenses, other systems can be selected where other types of viewing systems are used.

Preferably the glasses consist simply of a flat sheet carrying the lenses so that the structure is of a minimum material thus reducing the cost and bulk of the viewing system.

Preferably, where the viewing device is associated with the ticket, this can be carried with the ticket. In one arrangement, the ticket includes a covering sheet attached to one face of the substrate sheet material to define a pocket within which the viewing device is contained.

In another arrangement the viewing device can be supplied as an integral part of the ticket. The viewing device can then be removed by tearing along a line of weakness and used separately of the ticket, or the ticket can be folded so that a part of the ticket is viewable through the viewing device while the viewing device remains attached to the edge of the ticket. In both cases the viewing device can be located at one end of the ticket.

Where the viewing device is located in a pocket on one side of the ticket, preferably the covering sheet covers the whole of the face of the substrate sheet material but it can also be limited to a part only of the face.

Preferably the covering sheet is formed of a plastics material.

Preferably the covering sheet is transparent.

Preferably the substrate sheet material is larger in area than the ticket viewing device so that the ticket viewing device lies flat on a face of the substrate sheet material within edges of the face. This allows the glasses or other viewing device to be supplied in flat form.

In another arrangement a portion of the ticket substrate itself is folded over along one side to from a pocket into which the glasses are inserted. An alternative to this would be to first attach the glasses to the ticket and to then fold over one edge to form a pocket

Preferably the game indicia are located on a face of the substrate sheet material adjacent the viewing device. However the ticket can be arranged also in the reverse manner with the game indicia are located on a face of the substrate sheet material opposite the ticket viewing device.

According to a second aspect of the invention there is provided a game ticket assembly for playing by a player comprising:

a ticket comprising:

a substrate sheet material;

indicia printed on the substrate sheet material including:

promotional graphics printed on the substrate sheet material;

game information printed on the substrate sheet material;

and game indicia printed on the substrate sheet material;

some or all of the game indicia being covered by a material removable by the player;

wherein the ticket includes a covering sheet attached to one face of the substrate sheet material of a different material from the substrate sheet material to define a pocket within which an object is contained.

The covering sheet may cover the whole or a part only of the face of the substrate sheet material.

The covering sheet is preferably formed of a transparent plastics material. Although other materials different from and preferably much simpler and less expensive than the ticket substrate can be used, the ticket substrate itself can be folded over to form a self enclosed pocket which would contain the glasses.

The arrangement described herein therefore provides both a 3D concept and also an alternative packaging process that has evolved from the development into 3D and which is applicable to other types of products including a gift card.

The arrangement herein therefore provides a lottery ticket with glasses integrated into the ticket. There are other variations as well which include the positioning of a removable viewer along one side or across the top of the ticket.

The disposable 3D glasses are typically made of cardboard.

The inserted object such as a gift card or the glasses can incorporate a covered PIN or a bar code. Once the player removes the scratchoff the PIN or barcode is revealed which can be subsequently entered onto a website to provide various functions including the possibility of winning prizes, entering a draw, viewing a 3D picture gallery which contains graphic images to be seen with the glasses, etc.

We envision that the glasses will be also packaged individually and would be available for sale adjacent to the lottery ticket display. The use of cardboard glasses is common and they can be purchased either plain or printed with various graphic messages.

On the ticket, conventional printing techniques for the variable data are used, typically covered by scratchoff, and applied over a lily-pad which features images printed using the various colors associated. In order to provide the three dimensional effect, the game data and or other indicia on the ticket are printed using a conventional 3D system such as the Red/Blue or ChromaDepth concept. As the player is removing the scratchoff, if they wear the glasses, the images of the game data will appear to be at varying levels. The 3D effect can be applied to the game data only and/or to the other images or indicia on the ticket such as over the scratch-off and in the promotional material applied to the front and/or rear of the ticket.

The arrangement also provides an alternate packaging method which can be used not only for the glasses of the 3D concept but also for other objects such as prize cards or gift cards. In most cases the object is flat but it can also have some raised aspects. Other objects can be as follows:

merchandise or free ticket coupons;

bonus lottery ticket;

2nd chance draw ticket—internet or deposit at retailer;

website entry coupon.

This packaging process can supersede or replace other systems previously used such as metalized plastic pouches which enclose instant lottery tickets; laminated products which incorporate instant games on the inside panels of the front and back. The product is formed by bringing one panel into contact with the other and sealing with adhesives; or packages in which tickets are inserted into a pouch formed by folding a printed piece onto itself and sealing the edges. All of these are produced either in singles or in fan-folded format

The pouch described herein utilizes the ticket itself as one of the two layers in the final assembly. Basically the package features a ticket, with an attached item (3D glasses, gift card, etc.) onto which a film of plastic is applied over the entire front or back surface of the ticket and which is then sealed along the four edges to form a self-contained pouch. Optionally the film could be applied over a portion of ticket and sealed in the same manner. Tickets/pouches formed in this manner can be sold either in singles or in continuous fan-folded books. Typically the film will be clear but can be printed with additional graphical information. Film may be perforated down the middle to assist in the opening of the pouch.

Advantages of this method are:

1. Less expensive due to the reduction of material contained in the package. The ticket forms a dual purpose as both a fully functional ticket and the base for the package.

2. More environmentally compatible due to the reduction of material incorporated into the pouch

3. More compatible with different types of dispensing systems commonly used in the lottery industry

The game provided on each ticket may be for prizes both monetary and product related or may be merely for entertainment where no gambling or prize is involved. The type and value of any prizes can vary widely. The games may be predetermined, otherwise known as “instant win” tickets or may include elements of skill or chance. The games may include a scratch-off-coating which is convenient and effective particularly for instant win type game tickets, but other types of games which do not include scratch-off may be used.

The games concerned are preferably instant win type games where the result is entirely predetermined, since such games are generally preferred in a lottery situation in order to ensure that the total winnings is predetermined. However the present invention is not limited to the type of game to be played and can include probability or other games which include game indicia covered by a scratch-off coating.

The construction may also be used in situations where the main objective is for other purposes than gambling such as in promotional games or games of fun for children or others where no gambling or prizes are involved.

Many such tickets are used directly in a lottery situation so that the tickets have no other relevance other than the playing of the lottery or game by which the player may win monetary or other prizes as part of the lottery or gaming situation.

However more attention has been recently given to the use of such tickets as promotional items used by manufacturers of other products to enhance the sale of the product.

The scan method could be used to win free merchandise prizes, discount certificates for subsequent purchases, etc.

### BRIEF DESCRIPTION OF THE DRAWINGS

One embodiment of the invention will now be described in conjunction with the accompanying drawings in which:

FIG. 1 is a schematic illustration of the components of one embodiment of the apparatus according to the present invention where the viewing device is contained in a pocket formed on the ticket.

FIG. 2 is a transverse cross sectional view of the ticket of FIG. 1 with the game data on a side of the ticket which is opposite to the pocket.

FIG. 3 is a transverse cross sectional view of a ticket similar to that of FIG. 1 with the game data on a side of the ticket which is adjacent to the pocket.

FIG. 4 is a schematic illustration of a second embodiment of the apparatus in which the viewing device is attached as an integral part of the ticket.

FIG. 5 is an isometric view of the ticket of FIG. 4 with the ticket and viewing device folded into a viewing position.

FIG. 6 is a schematic illustration of a third embodiment of the apparatus in which the viewing device is contained within a pocket on the ticket.

In the drawings like characters of reference indicate corresponding parts in the different figures.

### DETAILED DESCRIPTION

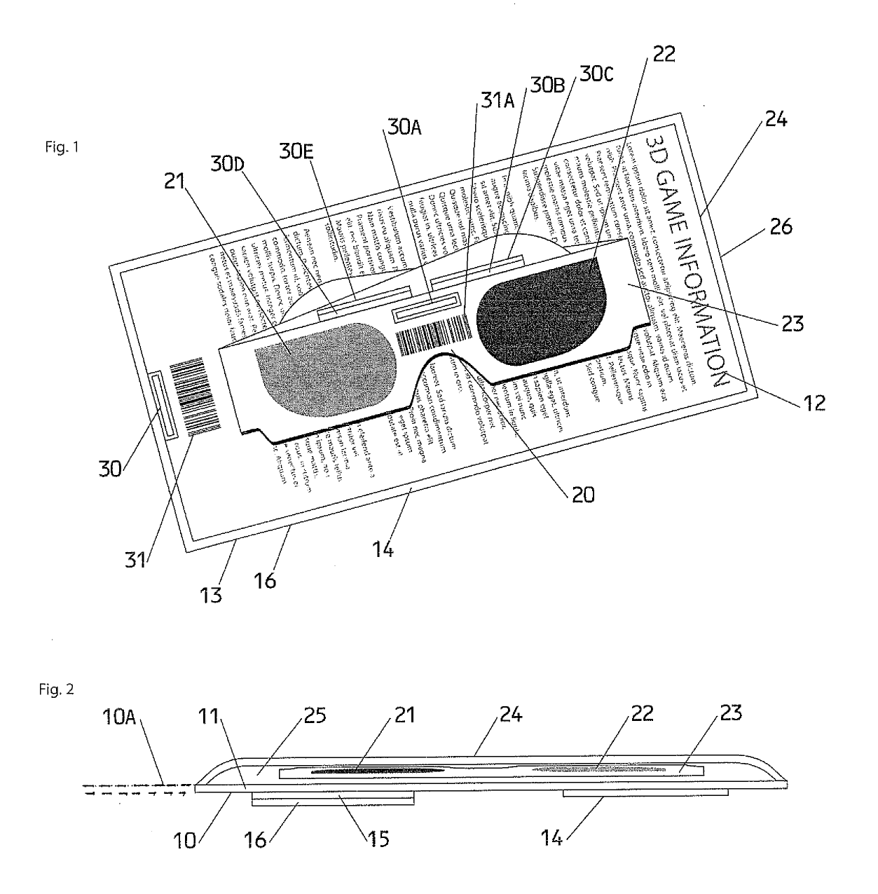

In FIGS. 1 and 2 is shown a game ticket assembly for playing by a player which is defined by a ticket 10 formed of a substrate sheet material 11. The substrate sheet material is of a conventional ticket stock with the conventional security requirements applied to form a suitable material for a secure ticket. The sheet material is typically a single layer forming an instant win ticket featuring a scratch-off layer covering variable imaged game data. However the ticket can be of the break-open type typically formed from multiple layers. The ticket can be a single item or can be formed as a typical fan folded strip including a row of tickets 10, 10A.

The indicia 12 printed on the substrate sheet material includes promotional graphics 13 and game information 14. Game data or indicia 15 is printed on the substrate sheet material and covered by a material 16 removable by the player.

In the above regard the ticket is typical and can include any of the variables and options available in the market.

The ticket also includes a ticket viewing device 20 in the form of glasses usable by the player for viewing the ticket. At least some of the indicia are printed in a manner which cooperates with the ticket viewing device using the above 3D technique so that some or all the game indicia 15 are visible to the player in a three dimensional format in which some parts of the indicia are apparently transported out of a two dimensional plane of the substrate sheet material. Some or all of the game information 14 and graphics 13 can also be printed in the 3D format.

The ticket viewing device is associated with the ticket in that it is attached to the ticket for transportation therewith so that each of a series of tickets has a respective ticket viewing device associated with it.

The ticket viewing device comprises glasses 20 including a substrate or sheet 23 carrying two lenses 21 and 22 for the eyes of the player. The substrate 23 itself may also be printed with additional a scratchoff area 30B and 30D covered by a scratch-off layer 30C and 30E. Where the substrate 23 forms an additional separate game ticket, this will include a ticket number 30A and a barcode 31A. For simplicity, as shown in FIG. 2, the glasses consist simply of the flat sheet 23 carrying the lenses 21, 22.

The ticket includes a covering sheet 24 of a transparent plastics material attached to the top face of the substrate sheet 11 material to define a pocket 25 within which the glasses 20 are contained. The covering sheet 24 covers the whole of the face of the substrate sheet material and is laminated to the sheet by a surrounding band 26 of a suitable adhesive. In a preferred arrangement this is carried out by providing a film which is pre-coated with a heat-sealable adhesive. During the packaging process a heated roller/anvil is applied around the periphery of the ticket so that the bonding occurs where the heated sealer is brought into contact with the film. If the covering material is applied to only a portion of the substrate or a portion of its periphery then the sealing will occur at that point.

As shown in FIG. 1, the substrate sheet material 11 is larger in area than the glasses 20 so that the flat sheet of the glasses lies flat on a face of the substrate sheet material within edges of the face.

In FIG. 2 the game indicia 14 and the scratch-off layer 15 are located on a face of the substrate sheet material opposite the glasses 20 and the cover sheet 24.

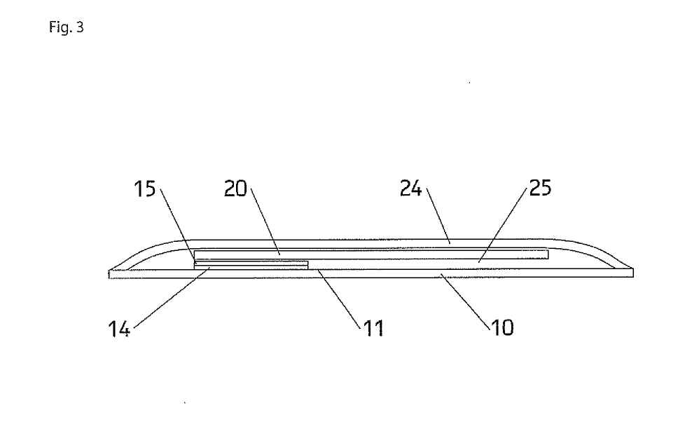

In FIG. 3 the game indicia 14 and the scratch-off layer 15 are located on an inside face of the substrate sheet material 11 adjacent the glasses 20 and the cover sheet 24 within the hollow interior 25.

The glasses and/or the ticket can carry a number in the form of a PIN 30, 30A or barcode 31, 31A. These numbers can be transmitted to a web site via the Internet using a computer to access the web site or via telecommunications from a handheld personal communications device.

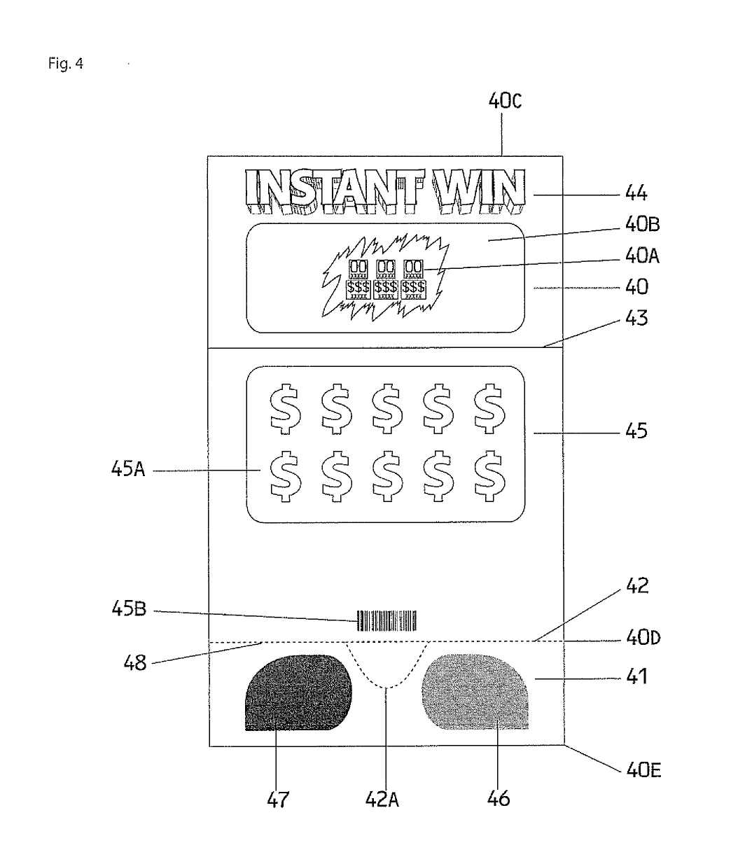

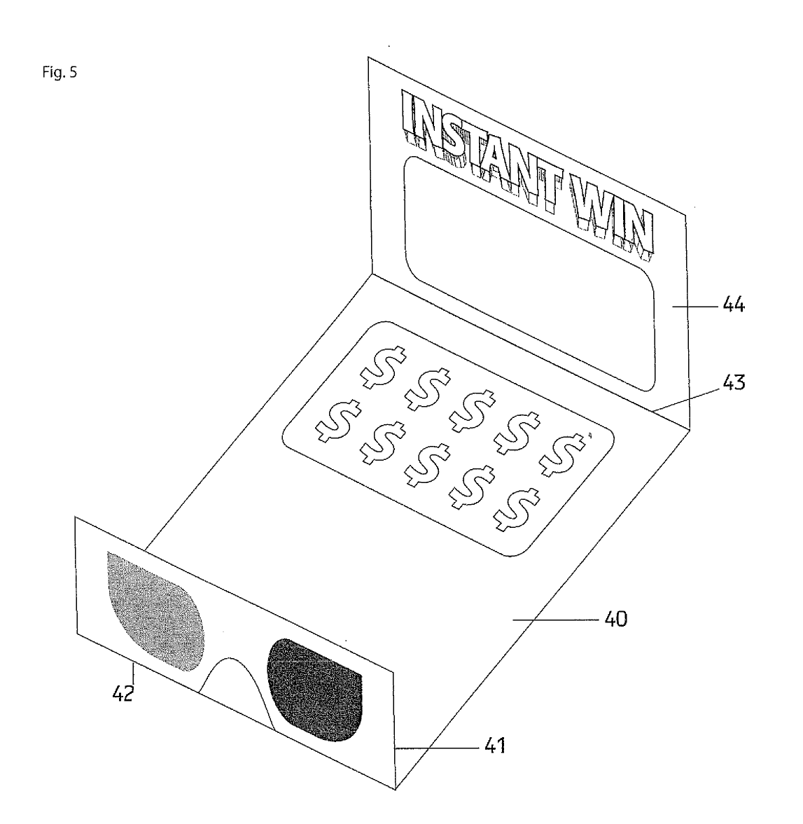

FIG. 4 shows a second embodiment including a ticket 40 with game data 40A covered by a layer of scratch-off material 40B. The ticket has ends 40C and 40E which can be attached to a chain of tickets or the ticket can be a separated from the chain. In this arrangement, the viewing device 41 is attached as an integral part of the ticket. This can be attached along one side but in the embodiment shown is at the end 40D.

The viewing device has at its edge 48 a line of weakness 42 between the viewing device and the ticket 40. This allows the viewing device to be separated from the ticket where the line is tearable or torn for use with the ticket separated. However the line 42 may be designed for folding of the viewing device at the line so that it folds up into the right angle position shown in FIG. 5 with the ticket and viewing device folded into a viewing position. Thus the ticket, as shown in FIG. 5, includes a fold at the line 42 and a second transverse bend line 43 allowing a portion 44 to be folded upwardly at right angles to the portion 45. In this way the ticket and the viewing device when they remain attached provide an integral structure for showing the game data and/or the printed material thereon applied over the base and/or scratch-off layer to be viewed in 3D through the lenses 46 and 47. The line 42 can include a center curved portion 42A to form a recessed portion which fits over the bridge of the nose when the device is folded. This piece can tear away in the situation where the viewing device is separated to form the glasses. The portion 45 is sufficiently long to hold the game data or ticket graphics away from the viewing device for a viewing distance to allow the viewing of the game data through the lenses and for the 3D effect to be obtained. The portion 45 can be used to carry the game information and other data of the ticket including the bar code 45B.

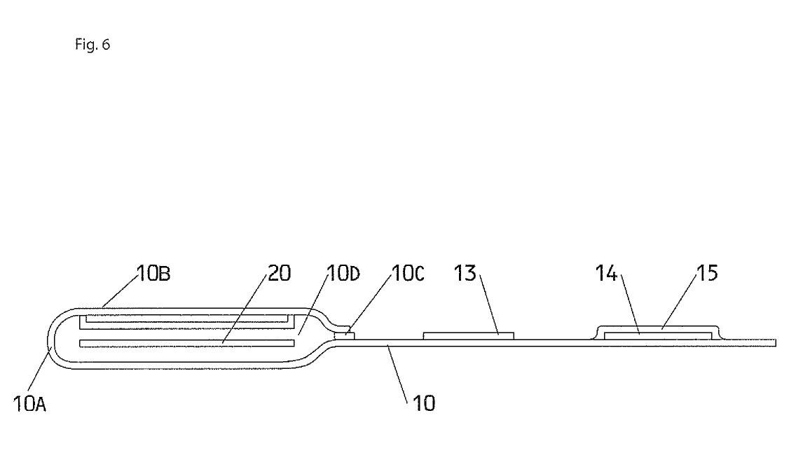

In FIG. 6 is shown an alternative arrangement in which the pocket is formed by folding an edge portion 10B of the sheet 10 back at a fold line 10A to form a hollow interior 10D which receives the glasses 20. The pocket can be sealed around three edges so that it is fully enclosed by a sealing band 10C or the pocket may be partly open at one or more edges.

Since various modifications can be made in the invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A game ticket assembly for playing by a player comprising:
a ticket comprising:
a substrate sheet material;
indicia printed on the substrate sheet material including:
promotional graphics printed on the substrate sheet material;
game information printed on the substrate sheet material;
and game indicia printed on the substrate sheet material;
some or all of the game indicia being covered by a material removable by the player;
and a ticket viewing device usable by the player for viewing the ticket;
at least some of the indicia being printed in a manner which cooperates with the ticket viewing device so that the indicia are visible to the player in a three dimensional format in which some parts of the indicia are apparently transported out of a two dimensional plane of the substrate sheet material.

2. The game ticket assembly according to claim 1 wherein the ticket viewing device is associated with the ticket so that each of a series of tickets has a respective ticket viewing device associated therewith.

3. The game ticket assembly according to claim 1 wherein the ticket viewing device is attached to the ticket for transportation therewith.

4. The game ticket assembly according to claim 1 wherein the ticket viewing device comprises glasses including two lenses for the eyes of the player.

5. The game ticket assembly according to claim 1 wherein the glasses consists simply of a flat sheet carrying the lenses.

6. The game ticket assembly according to claim 1 wherein the ticket includes a covering sheet attached to one face of the substrate sheet material to define a pocket within which the ticket viewing device is contained.

7. The game ticket assembly according to claim 1 wherein the covering sheet covers the whole of the face of the substrate sheet material.

8. The game ticket assembly according to claim 1 wherein the covering sheet is formed of a plastics material.

9. The game ticket assembly according to claim 1 wherein the covering sheet is transparent.

10. The game ticket assembly according to claim 1 wherein the substrate sheet material is larger in area than the ticket viewing device so that the ticket viewing device lies flat on a face of the substrate sheet material within edges of the face.

11. The game ticket assembly according to claim 1 wherein a portion of the substrate is folded over along one edge to form an integral pocket into which the viewing device is inserted

12. The game ticket assembly according to claim 1 wherein the game indicia are located on a face of the substrate sheet material adjacent the ticket viewing device.

13. The game ticket assembly according to claim 1 wherein the game indicia are located on a face of the substrate sheet material opposite the ticket viewing device.

14. The game ticket assembly according to claim 3 wherein the viewing device is attached as an integral part of the ticket.

15. The game ticket assembly according to claim 14 wherein the viewing device is attached to one edge of the ticket.

16. The game ticket assembly according to claim 14 wherein the viewing device is attached to the ticket by a line of weakness allowing it to be separated from the ticket.

17. The game ticket assembly according to claim 14 wherein the viewing device is attached to the ticket by a line of weakness allowing it to be bent relative to a main body of the ticket and relative to a viewing portion of the ticket so that the viewing portion can be viewed while the viewing device remains attached to the ticket.

18. A game ticket assembly for playing by a player comprising:
a ticket comprising:
a substrate sheet material;
indicia printed on the substrate sheet material including:
promotional graphics printed on the substrate sheet material;
game information printed on the substrate sheet material;
and game indicia printed on the substrate sheet material;
some or all of the game indicia being covered by a material removable by the player;
wherein the ticket includes a covering sheet attached to one face of the substrate sheet material of a different material from the substrate sheet material to define a pocket within which an object is contained.

19. A game ticket assembly for playing by a player comprising:
a ticket comprising:
a substrate sheet material;
indicia printed on the substrate sheet material including:
promotional graphics printed on the substrate sheet material;
game information printed on the substrate sheet material;
and game indicia printed on the substrate sheet material;
some or all of the game indicia being covered by a material removable by the player;
wherein a portion of the substrate is folded over along one edge to form an integral pocket within which an object is contained.
